(19) United States
(12) Patent Application Publication
(10) Pub. No.: US 2013/0228296 A1
(43) Pub. Date: Sep. 5, 2013

(54) WINDOW SECURITY SCREEN AND LATCH ASSEMBLY

(71) Applicants: Douglas SMITH, Spring Grove, PA (US); Scott BEVERIDGE, York, PA (US); Christopher GEESEY, Dover, PA (US)

(72) Inventors: Douglas SMITH, Spring Grove, PA (US); Scott BEVERIDGE, York, PA (US); Christopher GEESEY, Dover, PA (US)

(73) Assignee: HARMONY PRODUCTS, INC., Emigsville, PA (US)

(21) Appl. No.: 13/410,379

(22) Filed: Mar. 2, 2012

(51) Int. Cl. E05C 1/10; E05C 1/12; E06B 9/52

(52) U.S. Cl. 160/371; 292/138; 292/164; 292/145

(57) ABSTRACT

A window security screen and latch assembly are disclosed. The window security screen includes a screen frame, an infill attached to the screen frame and a latch assembly attached to the screen frame. The latch assembly includes a latch housing, a locking pin extending through the latch housing and through a side of the screen frame to establish a locked position, and a latch release disposed within the latch housing. The latch release is biased to prevent the locking pin from moving from the locked position in the absence of an external force applied to the latch release, the locking pin being movable between the locked position and an unlocked position when the external force is applied to the latch release.

### FIELD

This application is directed to security screens and more particularly to a latch assembly for a window security screen.

### BACKGROUND

Window security screens look similar to insect screens. Functionally, however, window security screens are much sturdier and stronger than insect screens. Window security screens are typically made of a heavy gauge wire cloth or a perforated metal panel mounted inside a screen frame and can protect windows from external penetration and/or against breakage by rocks or other items that may be accidentally or intentionally directed toward the window. Window security screens are increasingly installed over windows in many institutional and commercial settings because these screens provide enhanced protection from crime and vandalism, while having a less noticeable impact on the aesthetic appearance and architecture compared to traditional alternatives such as bars, metal shutters, and the like.

In addition to protection from external forces that might penetrate a window, including those resulting from crime and vandalism attempts, window security screens also provide much greater safety over insect screens from internal penetration and are useful in preventing tragic events such as small children that occasionally fall through an open window covered only by a closed insect screen. Despite these benefits, window security screens are not widely used in single-family homes or other conventional residential settings outside of public housing. Security screens may be perceived as less user-friendly than insect screens and may also be perceived to have a negative aesthetic effect that is more easily noticed in a residential environment than in commercial or institutional environments.

Various solutions have been presented to address the aesthetic concerns, including providing security screens designed to fit within the screen track typically provided in a window for a traditional insect screen. However, window security screens heretofore have still failed to be sufficiently user-friendly to encourage their use, even where aesthetic considerations can be addressed. One of the main challenges to this effort is to provide a user with an ability to readily open and/or remove the screen both for casual use, as well as for escape in an emergency, while still ensuring that the security screen cannot be readily compromised via the exterior side or opened by a child on the interior side.

What is needed is a latch assembly for use in combination with a window security screen that permits the security screen to be installed within the screen window track of a window, while allowing it to be opened quickly and easily from the interior by an adult while meeting current child safety considerations.

### SUMMARY

In one embodiment, a latch assembly for attaching a screen to a window frame comprises a latch housing, a locking pin extending through the latch housing sized to extend through a side of the screen and into the window frame, and a latch release disposed within the latch housing. The latch release is biased to prevent the locking pin from moving in a direction away from the side of the screen in the absence of an external force applied to the latch release.

In another embodiment, a window security screen comprises the latch assembly, a screen frame and an infill attached to the screen frame, the latch assembly attached to the screen frame.

An advantage of certain embodiments is that the latch assembly can be employed with a window security screen mounted in the window screen track of a window to permit the security screen to easily be opened and/or removed via the interior but not the exterior.

Another advantage of certain embodiments is that the latch assembly permits the security screen to be removed by an adult without the use of tools.

Yet another advantage of certain embodiments is that the latch assembly cannot be readily opened from the interior by a child.

Other features and advantages of the present invention will be apparent from the following more detailed description of exemplary embodiments, taken in conjunction with the accompanying drawings which illustrate, by way of example, the principles of the invention.

### BRIEF DESCRIPTION OF THE DRAWINGS

FIG. 1 illustrates a window security screen mounted within a window in accordance with an exemplary embodiment.

FIG. 1a illustrates a partial enlarged view of the window security screen of FIG. 1.

FIG. 2 illustrates a perspective view of a latch assembly in accordance with an exemplary embodiment.

FIGS. 3-5 provide a cross-sectional plan view of the latch assembly of FIG. 2 that illustrates latch operation.

FIG. 6 illustrates a plan view of a latch assembly in accordance with another exemplary embodiment.

Where like parts appear in more than one figure, it has been attempted to use like reference numerals to identify such parts.

### DETAILED DESCRIPTION OF EXEMPLARY EMBODIMENTS

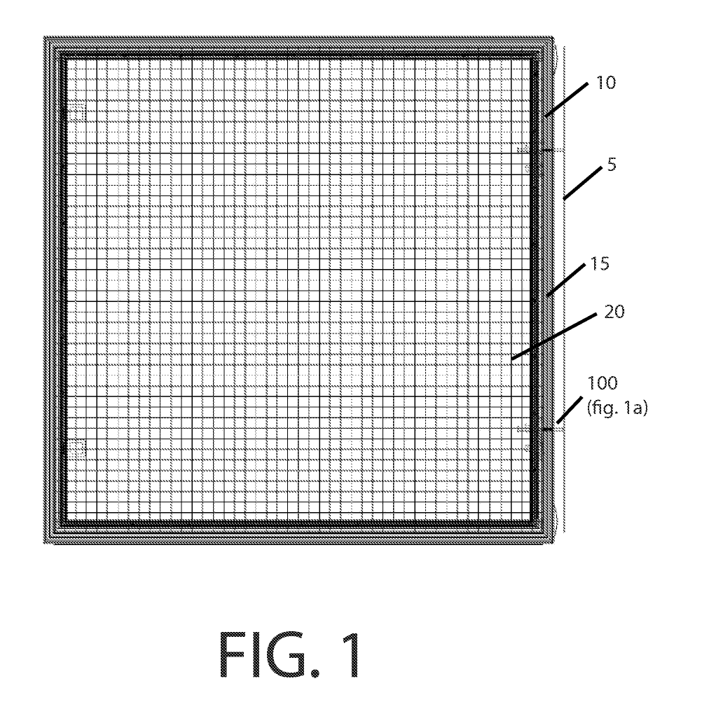

FIG. 1 illustrates an exterior view of a window security screen 10 mounted within a window frame 5 of a window of a home. More specifically, the window security screen 10 is mounted within a window screen track formed in the window frame 5, which is a common feature formed in most windows to receive and retain an insect screen. The window security screen 10 is locked in place within the frame 5 by a latch assembly 100 attached on an interior side of the screen 10. It will further be appreciated that while exemplary embodiments are described herein in the context of a latch assembly 100 for a window security screen, the latch assembly 100 might also be useful with traditional insect screens or in other applications.

The screen 10 has a frame 15 and infill 20. In embodiments in which the screen 10 is a window security screen, the frame 15 is typically constructed of an extruded galvanized steel or aluminum, although any material that provides sufficient strength may be used. The infill 20 for the window security screen 10 may be a perforated metal panel or a wire mesh, for example. Typically, for embodiments in which the infill 20 is a perforated panel, the panel is generally selected as a 12 gauge, 16 gauge, or 18 gauge steel panel depending upon the environment in which the screen 10 will be used and the level of protection desired. For embodiments in which the infill 20 is a wire mesh, the mesh is typically selected to be 0.028 in. wire mesh, 0.023 in. wire mesh, or 0.047 in. wire mesh and may be constructed of stainless steel or other suitable material. It will be appreciated, however, that the materials of construction of the frame 15 and the types and sizes of infill 20 are exemplary only, and that any materials used in the security screen industry may be employed with security screens 10 in accordance with exemplary embodiments.

The screen frame 15 may be constructed so that it is generally flush with at least a portion of the window frame 5 when the screen 10 is installed. This may aid in preventing crowbars, screwdrivers, or other burglar's tools from gaining a foothold for prying the screen 10 from the window frame 5 from the exterior. The latch assembly 100 operates independent of the depth of screen track, which can vary by manufacturer and typically ranges from 0.25 inches to 0.5 inches.

The latch assembly 100 is positioned on the interior side of the screen 10. It secures the screen 10 to the window frame 5 and provides a user with an ability to remove the screen 10 from the window frame 5 without the aid of additional tools and without compromising the security the screen 10 provides from vandals or burglars. Because of the high strength infill 20 used with the security screen 10 and its corresponding resistance to knives and cutting tools, the latch assembly 100 cannot be readily accessed from the outside.

The window security screen 10 may include multiple latch assemblies 100 positioned at various locations about the screen 10, for example, near each of the four corners. Alternatively, a single latch may be sufficient to secure the screen 10 within the screen track of the window frame 5. FIG. 1 a illustrates an enlarged view of the latch assembly 100 attached to the frame 15 of the window security screen 10, viewed from the interior of the home. The infill 20 is omitted from FIG. 1a for purposes of illustration. FIG. 1a also illustrates an exemplary cross-sectional profile of the extruded screen frame 15, which is one way in which enhanced strength can be achieved in the screen frame 15 for its use in security screen 10.

The latch assembly 100 includes a latch housing 110, a locking pin 120 and a release 140 that together provide for a two-step latch that results in the latch assembly 100 being child resistant and which can be actuated without tools. Thus, exemplary embodiments are compliant with ASTM Designation F2090-10 entitled “Standard Specification for Window Fall Prevention Devices with Emergency Escape (Egress) Release Mechanisms,” which is hereby incorporated by reference.

The latch assembly 100 may be secured to the screen frame 15 by screws or other fasteners. The locking pin 120 extends from the latch housing 110 through the screen frame 15 into the window frame (not shown in FIG. 1a), thereby securing the screen 10 to the window frame. When released, the locking pin 120 can be withdrawn from the window frame, permitting the entire screen to be removed from the window frame for repair, maintenance or other reason, as well as to provide egress in case of emergency.

Alternatively, in some embodiments, the screen frame 15 may be attached to the window frame by screws or other fasteners, for example, while the infill 20 is hingedly attached to one side of the screen frame 15. In such cases, the latch assembly 100 may be used to lock the infill 20 to the screen frame 15, such that when the latch assembly 100 is unlocked, the infill 20 can be swung open via its hinges to provide egress in case of emergency, while the screen 10 itself remains secured to the window frame 5.

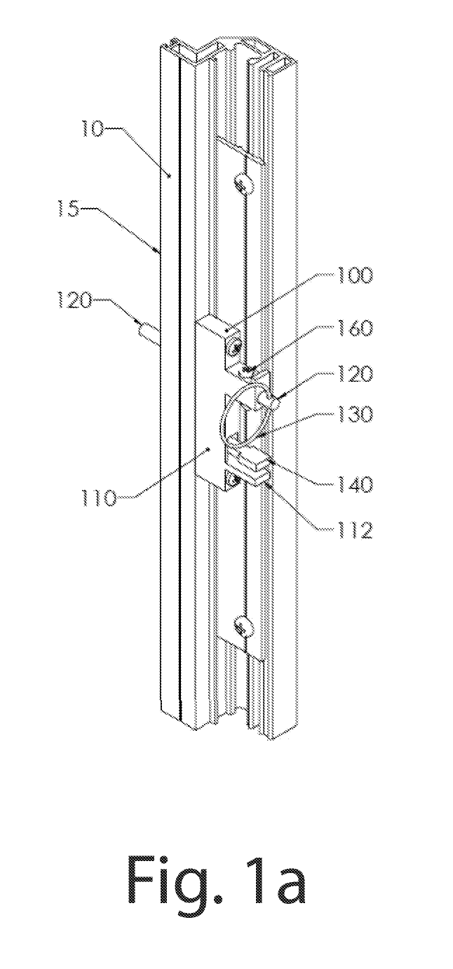

Turning to FIG. 2, the latch assembly 100 is shown with the position of the screen frame 15 and window frame 5 shown schematically in broken line for context in the illustration. The locking pin 120 may include a handle 130, illustrated here as a pull ring, to aid a user in withdrawing the locking pin 120 from the window frame 5 after the release 140 has been activated. The pull ring is exemplary only and the handle 130 may be a tab, a tee, an eye hook, or any other feature that aids in grasping the locking pin 120.

The release 140 is partially disposed within the latch housing 110 and exerts a bias force to resist axial movement by the locking pin 120 that keeps the latch assembly 100 in a locked position. As a result, the locking pin 120 cannot be retracted from the window frame 5 to remove or open the screen without a first action to counter the bias force of the release 140, followed by a subsequent, separate action of pulling the pin 120 away from and out of the window frame 5.

The latch housing 110 may also include a tab 112 that extends away from the frame 15. The tab 112 provides a convenient surface by which the release 140 can easily be activated by squeezing the release 140 and tab 112 with, for example, the thumb and forefinger.

The latch assembly 100 may also include a travel stop 160 that extends into the latch housing 110 to establish a point of maximum travel of the locking pin 120 away from the frame 15 so that the locking pin 120 is not pulled completely out of the latch assembly 100 and inadvertently misplaced. In the illustrated embodiment, the travel stop 160 may be a screw or other fastener which provides the option of adjusting the depth of the travel stop or the travel stop 160 can be removed entirely in situations where it is desired to entirely remove the locking pin 120 from the latch assembly 100, such as for cleaning.

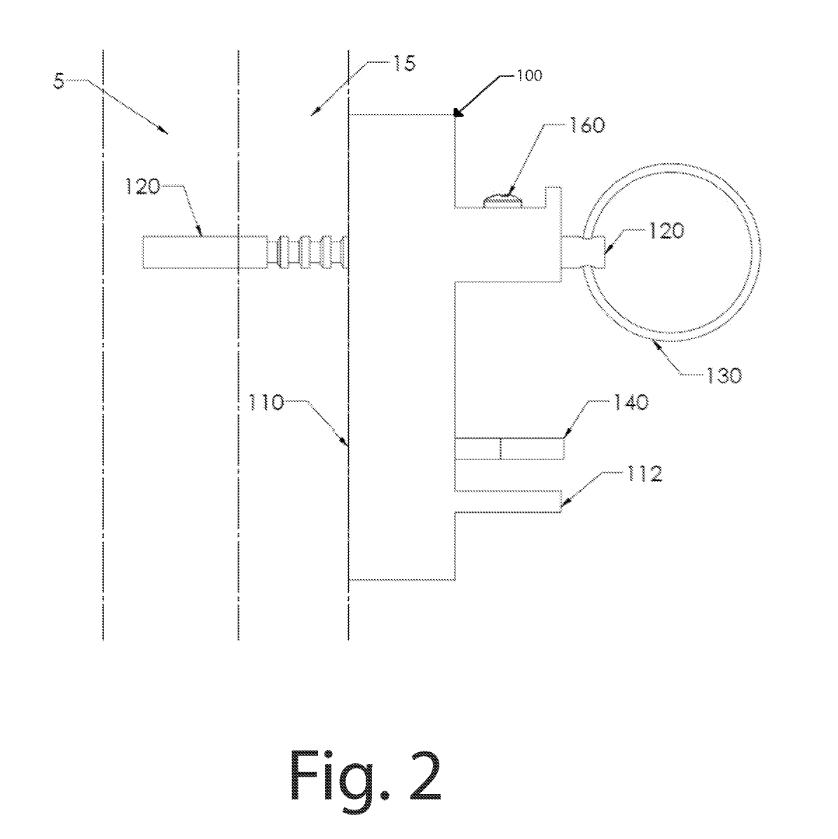

In FIGS. 3-5, a cross-sectional plan view of the latch assembly 100 from FIG. 2 is shown that sequentially illustrates a transition from the locked to the unlocked positions, in which the screen frame 15 and window frame 5 are again shown in broken line for purposes of illustration.

Beginning with FIG. 3, the latch assembly 100 is shown in the locked position, with the locking pin 120 resident in a locking pin channel 128 and fully extended through the screen frame 15 and into the window frame 5 to secure the screen to the window frame 5 within the screen track. The release 140 is biased to keep the locking pin 120 in that locked position. As illustrated, the bias force may be achieved by a spring 150 internal the latch housing 110 that forces a release catch portion 142 of the release 140 toward the locking pin 120.

To enhance the locking force exerted by the release 140 on the locking pin 120 in the biased position, the locking pin 120 may have a plurality of flutes 122 formed in the locking pin 120 in which the release catch 142 is received. As a result, any effort to extract the pin 120 by pulling it away from the window frame 5 is resisted by contact between the flute wall and an opposing wall of the release catch that extends into the flute 122 as a result of the bias force applied by the spring 150. It will be appreciated that while the locking pin 120 is shown and described as substantially cylindrical, any shape pin may be used and that any manner of applying a force to retain the locking pin 120 in its locked position may also be employed. The flutes 122 may be formed as grooves, threads or other features formed in the locking pin and may extend partially or entirely about the perimeter of the locking pin 120.

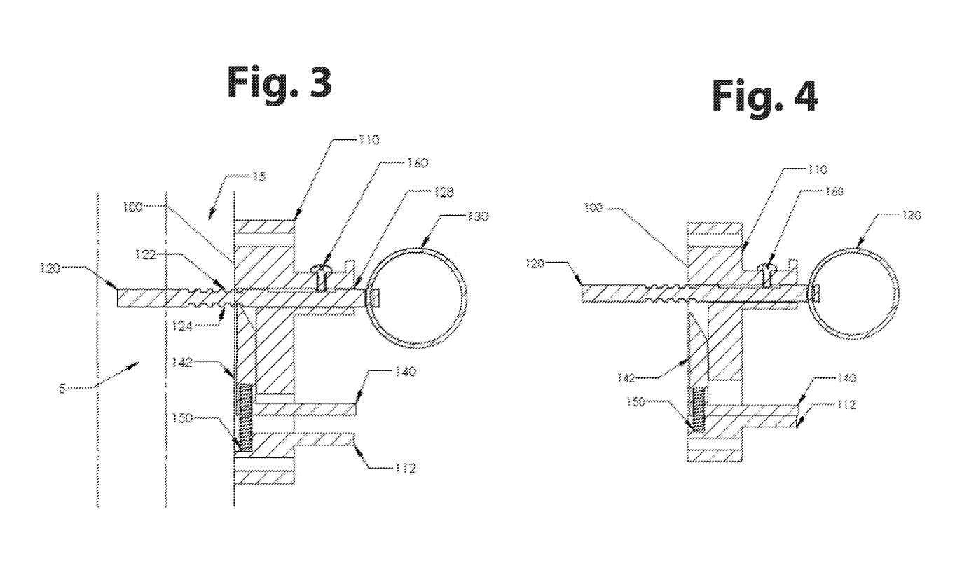

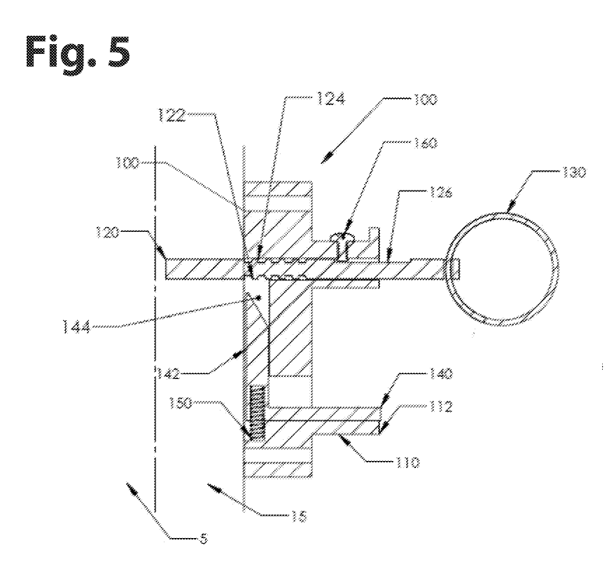

Turning to FIG. 4, the bias force exerted by the spring 150 that holds the release 140 in contact with the locking pin 120 can be overcome by exerting a compression force larger than the bias force, for example, by squeezing the release 140 and the latch tab 112. This force compresses the spring 150 and causes the release catch 142 to retreat from the flute 122 of the locking pin 120 in which it was situated. Once this first action is accomplished, the locking pin 120 is free to be pulled through its shaft 128 away from the window frame 5 as reflected in FIG. 5 by a second action that unlocks the screen 10 for opening and/or removal.

In some embodiments, the locking pin 120 may include multiple flutes 122. In that case, one of the flutes 122 may be positioned such that the release catch 142 is aligned with the additional flute when the locking pin 120 is in the open position. Thus, if the compression force is removed and the spring 150 returns the release 140 to its original biased position, the force now retains the locking pin 120 in the unlocked position. Thus, the user does not need to maintain the compression force while the screen 10 is being removed. This may be particularly useful if multiple latch assemblies 100 are used with a single security screen window 10, so that each latch assembly can be sequentially moved from the locked to unlocked position, even if that requires closing one sash of the window and opening another to gain access to a different part of the screen 10.

FIG. 5 also illustrates how a channel 126 formed in the locking pin 120 combined with a travel stop 160 can be used to define a distance of maximum travel for the locking pin 120 so that a user knows when the locking pin 120 has been moved a sufficient distance to fully extract it from the window frame 5 but without the need to pull the pin 120 all the way out of the latch housing 110.

As shown in FIGS. 3-5, in some embodiments the flutes 122 may include a beveled surface 124 that matches a beveled surface 144 of the release catch 142 that together form opposing inclined planes in the direction of pin insertion into the window frame 5. As a result, it may be possible to overcome the bias of the spring force during pin insertion without the need to compress the release 140 and latch tab 112. Thus, the latch assembly 100 can be moved to the locked position with a single action, despite the need for two independent actions to open the latch assembly 100 into the unlocked position.

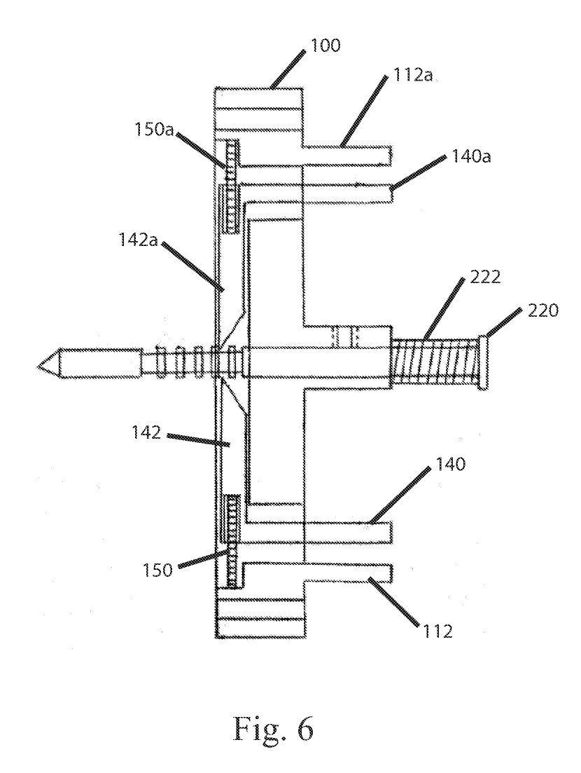

FIG. 6 illustrates another exemplary embodiment of a latch assembly 100. In this embodiment, a spring loaded locking pin 220 is provided that is biased toward the unlocked position by a locking pin spring 222 that is held in the compressed state when in the locked position by the release catch 142. As a result, when the release 140 and the latch tab 112 are squeezed to compress the spring 150 and the release catch 142 withdraws from the spring loaded locking pin 220, the locking pin spring 222 urges the spring loaded locking pin 220 toward the unlocked position. As a result, the user does not need to manually withdraw it through the pin channel.

As also shown in FIG. 6, a second release mechanism, such as a second latch release 140a having its own release catch 142a and biased toward the locked position by a second spring 150a may be employed on the opposite side of the latch assembly 100. While a second release mechanism can be used in any embodiment, it may be desirable in combination with those employing a spring loaded locking pin 220 so that a two-step release is still employed to provide a child-resistant latch assembly that can meet the safety standards described in ASTM F2090-10 as previously referenced with respect to other embodiments illustrated and described herein.

While the invention has been described with reference to particular embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A window security screen comprising:
a screen frame;
an infill attached to the screen frame; and
a latch assembly attached to the screen frame, the latch assembly comprising
a latch housing,
a locking pin extending through the latch housing and through a side of the screen frame to establish a locked position, and
a latch release disposed within the latch housing, the latch release biased to prevent the locking pin from moving from the locked position in the absence of an external force applied to the latch release, the locking pin being movable between the locked position and an unlocked position when the external force is applied.

2. The window security screen of claim 1, wherein the latch assembly comprises a spring disposed within the latch housing, wherein the spring provides the bias to the latch release.

3. The window security screen of claim 1, wherein the locking pin comprises at least one flute configured to receive a release catch of the latch release.

4. The window security screen of claim 3, wherein the flute has a beveled surface that matches a beveled surface of the release catch to form opposing inclined planes in a direction of movement of the locking pin toward the screen frame.

5. The window security screen of claim 3, wherein the locking pin comprises at least two flutes configured to receive the release catch, the first flute positioned to receive the release catch when the locking pin is in the locked position and the second flute positioned to receive the release catch when the locking pin is in the unlocked position.

6. The window security screen of claim 1, wherein the latch assembly further comprises a travel stop extending into the latch housing that defines a position of maximum travel of the locking pin away from the side of the frame when the external force is applied to the latch release.

7. The window security screen of claim 1, wherein the locking pin further comprises a handle.

8. The window security screen of claim 1, wherein the infill is selected from the group consisting of a perforated metal panel and wire mesh.

9. The window security screen of claim 1, wherein the locking pin is a spring loaded locking pin.

10. The window security screen of claim 9, further comprising a second latch release disposed within the latch housing to prevent the spring loaded locking pin from moving in a direction away from the side of the screen frame in the absence of a force applied to the second latch release.

11. A latch assembly for attaching a screen to a window frame, the latch comprising:
a latch housing;
a locking pin extending through the latch housing sized to extend through a side of the screen and into the window frame; and
a latch release disposed within the latch housing, the latch release biased to prevent the locking pin from moving in a direction away from the side of the screen in the absence of a force applied to the latch release to overcome the bias.

12. The latch assembly of claim 11, wherein the latch assembly comprises a spring disposed within the latch housing, wherein the spring provides the bias to the latch release.

13. The latch assembly of claim 11, wherein the locking pin comprises at least one flute configured to receive a release catch of the latch release.

14. The latch assembly of claim 13, wherein the flute has a beveled surface that matches a beveled surface of the release catch to form opposing inclined planes in a direction of movement of the locking pin toward the screen frame.

15. The latch assembly of claim 13, wherein the locking pin comprises at least two flutes configured to receive the release catch, the first flute positioned to receive the release catch when the locking pin is in the locked position and the second flute positioned to receive the release catch when the locking pin is in the unlocked position.

16. The latch assembly of claim 11, wherein the latch assembly further comprises a travel stop extending into the latch housing that defines a position of maximum travel of the locking pin away from the side of the frame when the external forces are separately applied to the latch release and the locking pin.

17. The latch assembly of claim 11, wherein the locking pin further comprises a handle.

18. The latch assembly of claim 17, wherein the handle is a pull ring.

19. A latch assembly for attaching a screen to a window frame, the latch comprising:
a latch housing;
a locking pin having a plurality of flutes formed therein, the locking pin extending through the latch housing and sized to extend through a side of the screen and into the window frame;
a latch release having a release catch disposed within the latch housing;
a spring disposed within the latch housing, the spring applying a bias force to force the latch release into a first flute formed in the locking pin to prevent the locking pin from moving to an unlocked position in a direction away from the side of the screen in the absence of a force applied to the latch release to overcome the bias force; and
a travel stop extending into the latch housing that defines a position of maximum travel of the locking pin away from the side of the window frame when the external forces are separately applied to the latch release and the locking pin.

20. The latch assembly of claim 19, wherein a second flute of the plurality of flutes is positioned to receive the release catch when the locking pin is in the unlocked position.
